(19) United States
(12) Patent Application Publication
(10) Pub. No.: US 2011/0263038 A1
(43) Pub. Date: Oct. 27, 2011

(54) PUNCH SAMPLING APPARATUS AND METHOD

(76) Inventors: Allan David Morrison, Queensland (AU); Bradley F. Davin, Seneca, SC (US)

(21) Appl. No.: 12/921,736

(22) PCT Filed: Feb. 25, 2009
(86) PCT No.: PCT/AU2009/000208

§ 371 Date: Mar. 8, 2011

Related U.S. Application Data
(60) Provisional application No. 61/031,290, filed on Feb. 25, 2008.

(51) Int. Cl. G01N 1/28; B01L 3/00

(52) U.S. Cl. 436/174; 422/500; 422/547

(57) ABSTRACT

A punching apparatus (10) and method for delivering disk samples (20) from media containing a dried bio-sample into a receptacle for use in an assay. In one aspect, the shape of the disk is altered, such as by folding, so that a disk of larger cross sectional size may fit into a receptacle having a cross sectional size less than the disk punched from the media.

### FIELD OF THE INVENTION

The present invention relates to improvements in devices designed to remove a portion from a bio-sample for use in an analysis.

### BACKGROUND OF THE INVENTION

Dried sample on media is becoming increasingly popular as the primary source of bio-sample used in assays in a range of applications.

High throughput situations call for automated solutions. This usually involves the use of standardised formats for sample receptacles, (e.g. standard sized test tubes) and the use of standardised formats for the racks to hold those tubes, or for the laboratory plates incorporating the receptacles (e.g. SBS footprint for plates/tube racks). Receptacles are almost always round in shape.

Typically, once a disk has been punched into a receptacle, liquid is then added to the receptacle as part of the processing. Often, after that processing, the liquid has to be drawn out of the receptacle, through devices such as pipettes, either manually or automatically. Sometimes as part of the flow of the liquid into the pipette tip, the punched disk becomes lodged on, or in the end of the tip, stopping the liquid flow. This is a common problem for laboratories using dried sample on media.

Furthermore, occasionally in some applications, the reaction with the liquid requires more sample material to be provided than can be found in a disk that is the same diameter as the receptacle. While it is possible using some instruments to punch multiple samples into the one receptacle, sometimes these multiple disks may come to rest in the bottom of the receptacle on top of each other, thus limiting the extent of contact between the liquid and the surface area of the punched disk (where the dried bio-sample is present). The present invention seeks to lessen these problems and/or provide more reliable, repeatable performance.

### SUMMARY

The invention in one preferred aspect involves punching a disk with a diameter larger than the diameter of the receptacle, folding that disk into a curved shape so that one of the resulting “gross” dimensions of the shape is less than the diameter of the receptacle, and then manipulating the travel of the folded disk when it is free of the punch at the end of its travel so that the long dimension is moved to a vertical orientation, and allows the folded disk to then fall via a special chute into the receptacle.

When the disk falls into the receptacle, it will often lodge itself against one part of the wall of the (round) receptacle, (i.e. so that the curve of the disk matches the curve of the receptacle wall) allowing for pipette tips to be inserted into the receptacle without interference from the punched disk. Often the curved disk will have a memory and move into a shape that further matches the curvature of the wall of the receptacle.

A further example would involve punching a rectangular disk to get greater sample material, but this does not offer the advantages that come as a result of the folded disk aligning itself against the wall of the receptacle and allowing access for pipettes of similar devices.

### BRIEF DESCRIPTION OF THE DRAWINGS

In order that this invention may be more readily understood and put into practical effect, reference will now be made to the accompanying drawings that illustrate preferred embodiments of the invention, and wherein:

FIG. 1 is a front view of a punching apparatus in accordance with a preferred embodiment of the present invention;

FIG. 2 is a partial cross sectional side view of the punching apparatus of FIG. 1 taken along line C-C of FIG. 1;

FIG. 3 is a partial cross sectional front view of the punching apparatus of FIG. 1 taken along line D-D of FIG. 2;

FIG. 4 is a sectional perspective view of a punching apparatus of another preferred embodiment of the present invention;

FIG. 5 is a front view of a punch for the punching apparatus of the other embodiment;

FIG. 6 is an enlarged sectional perspective view of a manifold for the other embodiment; and

FIG. 7 is an enlarged sectional perspective view of a chute for the other embodiment.

### DETAILED DESCRIPTION OF THE EMBODIMENTS

Alternative embodiments of the invention will be apparent to those skilled in the art from consideration of the specification and practice of the invention disclosed herein. It is intended that the specification and examples be considered as exemplary only, with a true scope and spirit of the invention being indicated by the claims which follow.

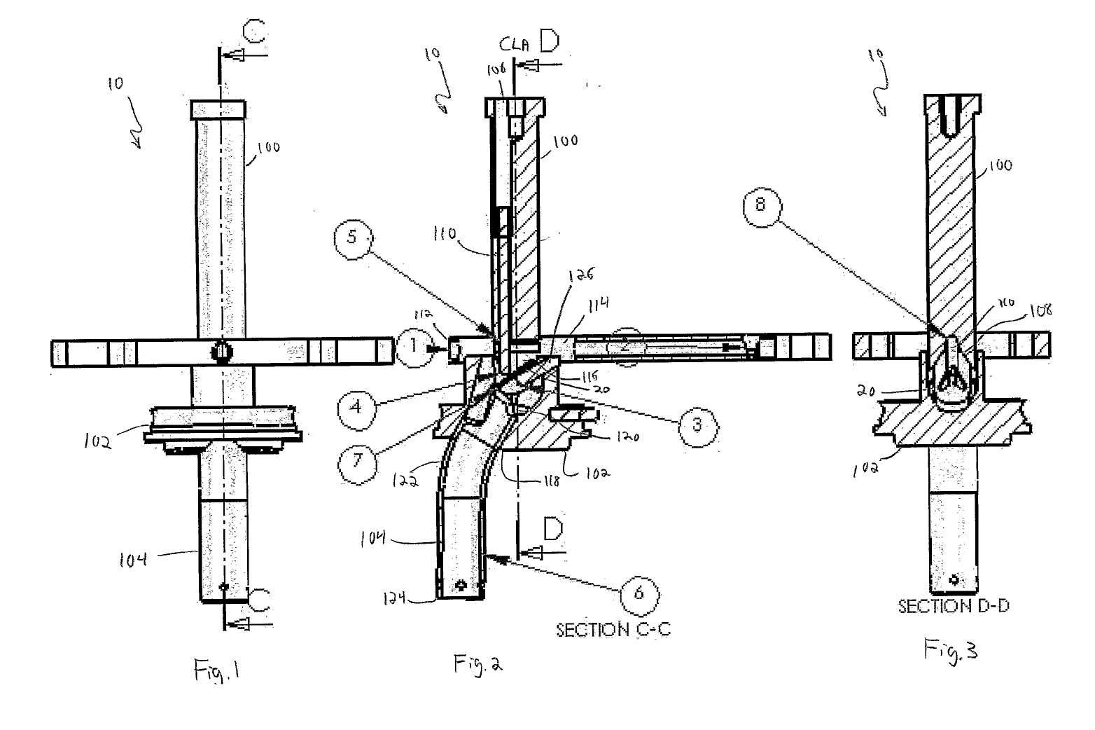

FIGS. 1 to 3 show a preferred embodiment of a punching apparatus 10 having a punch 100, a manifold assembly 102 and a chute 104. The preferred elements of and their interrelationship are described below.

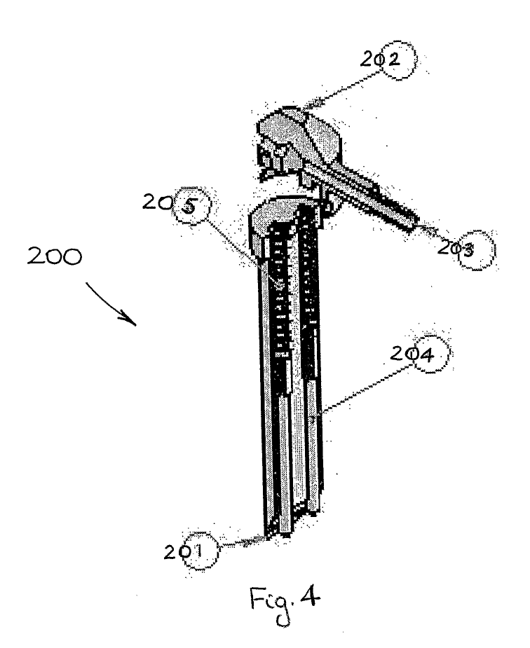

Referring to FIG. 2, punch 100 includes a passage 106 for passage of an ejector pin 110 therethrough. Punch 100 has a central longitudinal axis CLA. Passage 106 is preferably offset from the CIA of punch 100. Ejector pin 110 is adapted to encourage the disk of media removed by punch 100 to free itself from bottom 108 of punch 100 with one end of the long dimension of the folded disk moving downwards first. Ejector pin 110 is preferably associated with a spring mounted in the top part of passage 106.

Manifold assembly 102 is connected to punch 100 preferably immediately below the die plate of the punch. Manifold assembly 102 preferably includes an air inlet 112 for the inflow of air (using a small pump) on a side of the manifold opposite to where the vacuum is applied (direction 1) and an air outlet 114 to which a vacuum pump is connected, to extract dust from the manifold (in direction 2) as the punch and punched disk pass through manifold 102. Manifold assembly 102 further preferably includes an inlet cavity 116 in communication with bottom 108 of punch 100 and an outlet 118 for connection with chute 104.

As shown in FIG. 2, chute 104 preferably includes an inlet 120 for connection to outlet 118 of manifold assembly 102, a curved section 122 configured at an angle relative to the CLA of punch 100, and an outlet 124. Chute 104 further preferably includes a projection such as a pin 126 proximate inlet 120.

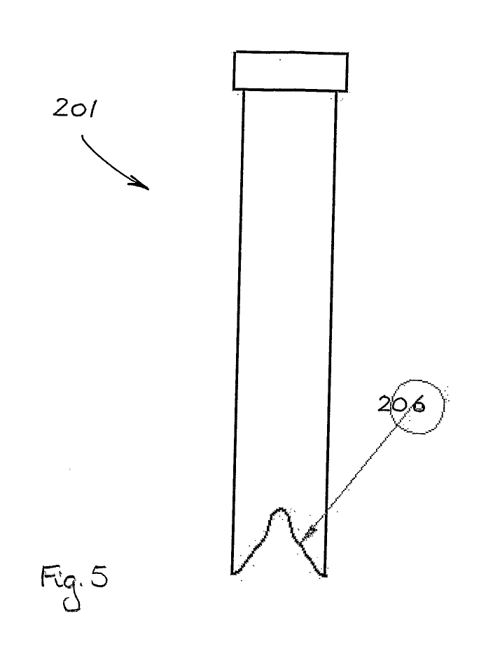

Having described the preferred components of the punch apparatus, a preferred method of use will now be described with reference to FIGS. 2 and 3.

Punch 100 is used to remove a portion 20 of the media containing the dried bio-sample. At least one ejector pin 110, (see 4 and 8 in FIGS. 2 and 3) in passage 106 (see 5) is preferably offset from CLA of punch 100 so as to encourage the disk 20 to free itself from bottom 108 of punch 100, with one end of the long dimension of the folded disk 20 moving downwards first. Air is introduced into the top of passage 106 (preferably to push down the leading edge of folded disk 20, but also to create positive air pressure in passage 106 to prevent paper dust from entering into that passage, which could potentially cause cross contamination between samples. Air may also be introduced laterally through manifold assembly 102 in the direction 2 (FIG. 2) to extract dust from the manifold as punch 100 and punched disk 20 pass through manifold assembly 102.

Punch 100 and disk 20 travel into a portion of chute 104, where the chute is essentially of a diameter slightly bigger than the small dimension of folded disk 20. The centre of chute 104 is preferably offset relative to the centre of punch 100. Pin 124 of chute 104 is preferably in contact with the trailing edge of folded disk 20 so as to briefly delay the fall of disk 20 as it becomes free of the punch (see 7 and 8 of FIGS. 2 and 3). The act of holding up the trailing edge of the folded disk, while positively ejecting the leading edge, causes folded disk 20 to adopt the preferred orientation in chute 104. Chute 104 is preferably controlled so that it is allowed to fall onto the top of the receiving receptacle immediately prior to the disk falling through the chute into the receptacle. The gap between outlet 124 of the chute and the receptacle might typically be in the range of approximately 1-3 mm.

Preferably chute 104 incorporates one or more detectors to confirm that disk 20 has passed successfully through the chute. Once this has been detected, then chute 104 is raised. In the event that the detectors do not detect that the disk has passed through chute 104, the system may be programmed to operate in such a way that chute 104 is moved up and down as necessary to dislodge the disk. The system preferably includes a computer-controlled means for bringing the appropriate receiving receptacle under the end of the chute.

It will be appreciated that certain of the steps described above may be performed in a different order, varied, or omitted entirely without departing from the scope of the present invention.

Another embodiment of the invention, which employs a straight (rather than curved) chute will be described with reference to a punching apparatus 200 depicted in FIGS. 4 to 7. The punching apparatus 200 shown in FIG. 4 includes a punch 201 and a punch cap 202, which cap incorporates an air intake 203. The punch 201 is operatively associated with two ejector pins 204 which are biased by respective ejector springs 205. The punch 201 has a cutting profile portion 206, as depicted in FIG. 5.

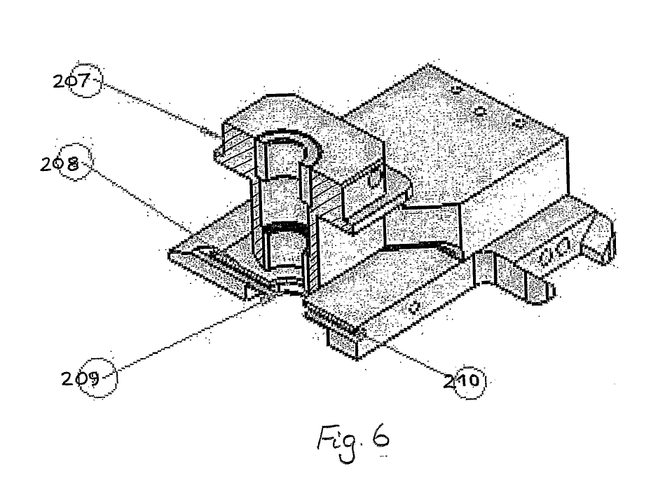

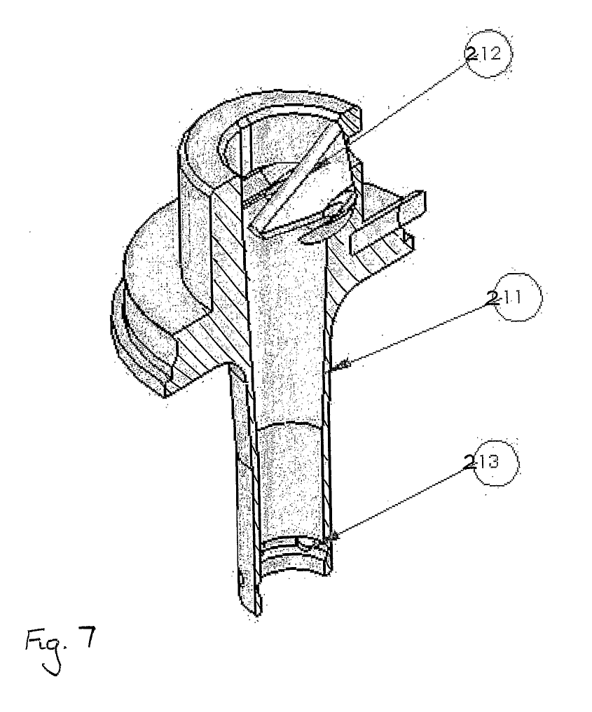

Turning to FIG. 6, there is shown a punch manifold including a punch guide 207 and a punch die 208 having an annulus 209. The manifold further includes a port 210 which is suitably used for application of a vacuum to extract unwanted particulate matter, such as dust particles created when a disk is punched from sample media, and other contaminants. A straight chute 211 for receiving punched disks from the cutting apparatus 200 is shown in FIG. 7. The chute 211 includes a deflector 212 at a first normally upper end and spot detectors 213 at a lower end thereof.

The springs 205 for the ejector pins 204 provide a downward force to assist release of a punched disk from the cutting profile 206 in the bottom portion of the punch 201. An ejector pin located at the front of the punch 201, where an edge of the disk is to be oriented downwards into the chute 211, is longer or the spring has a stronger bias or both.

The straight chute, which is suitably disposed vertically in FIG. 6, is designed to reduce the likelihood that punched disks will become lodged in the curved chute (FIG. 2), as may sometimes occur with the curved chute.

The air system into the punch depicted in FIG. 4 may be configured to either allow air pressure to be added into the ejector system to prevent the build-up of paper dust and/or lint around the holes in the bottom of the punch where the ejectors protrude, or alternatively, to have vacuum applied to remove that dust. In some applications, the positive pressure configuration has been found to be superior to the vacuum arrangement.

In some applications where the invention may be used, the sensitivity of the assay being undertaken on the sample may be such that even a very small amount of particle carry-over in the punching system from one sample to the next may be sufficient to throw the conclusions of the assay with respect to a second or subsequent sample into doubt. This is particularly the case where the assay in question is intended to diagnose whether the subject providing the sample has, or does not have a particular disease or disorder. Typically, the assays involve assessment processes such as those which amplify a specific DNA type such as a disease type.

It is known that the application of particular levels of Ultra Violet radiation, in the C range, typically with wavelengths in the range 230-280 nm, but especially around 254 nm, will damage DNA whether in hydrated or dehydrated states. Damaged DNA will not be amplified in the assessment process, and is therefore not recognised in an assay.

To substantially eliminate the potential for any particle carryover between one sample and the next to confuse the outcomes of the second assay, the device can been fitted, in one embodiment, with a UVC emitter which will be exposed to the appropriate surfaces of the device for a sufficient period to damage any remaining particles which may be a source of cross-contamination. This exposure occurs between the punching of each new sample. Any DNA on remaining particles is, as a result of the UV application, not recognised as being of the disease type being examined, and therefore does not confuse the results of the assay.

The appropriate surfaces of the device are those which either come into direct contact with the sample or those that come into contact with particles from the sample media that become loose from the sample during the handling, such as those, for example, that become airborne.

The foregoing description is by way of example only, and may be varied considerably without departing from the scope of the present invention. For example only, the floor of the concave section in the punch could be at an angle other than 90 degrees to the central longitudinal axis of the punch to assist in getting the disk to free itself from the end of the punch in such a way as to assist in its preferred orientation in the chute. Air could be used instead of the ejector pin in the punch. There could be two ejector pins in the punch, either of different lengths and with the same method of driving the disk off the punch, (e.g. two springs of the same size) or two ejectors of the same length, but with different means of driving the disk off the punch, i.e. providing more force of the leading edge of the disk than the trailing edge.

Examples of systems or elements of systems that may be adapted in conformity with the present invention include those described in U.S. Application No. 10/982,539, entitled “System and Method for Analysing Laboratory Samples,” (Publication No. 2005/0129579); U.S. Application No. 11/148,094, entitled “Method and Apparatus for Inspecting Biological Samples,” (Publication No. 2005/0287678); International Application No. PCT/AU2007/000171, entitled “Biological Sample Collection Device;” and International Application No. PCT/AU99/00485, entitled “a Punching Apparatus,” the disclosure of each being incorporated herein by reference.

The features described with respect to one embodiment may be applied to other embodiments, or combined with or interchanged with the features other embodiments, as appropriate, without departing from the scope of the present invention.

It will of course be realised that the above has been given only by way of illustrative example of the invention and that all such modifications and variations thereto as would be apparent to persons skilled in the art are deemed to fall within the broad scope and ambit of the invention as herein set forth.

1. A method of obtaining a portion of a media containing a dried bio-sample for use in an assay, comprising: removing a portion of the media containing the dried bio-sample;
altering the shape of the portion to have a non-circular horizontal cross section; and transferring the portion into a receptacle.

2. The method of claim 1, wherein altering the shape of the portion comprises folding the portion to have the non-circular horizontal cross section.

3. The method of claim 1, wherein transferring the portion comprises moving the portion through a chute having a maximum cross sectional dimension less than the maximum cross sectional dimension of the portion.

4. The method of claim 1 , wherein removing the portion comprises punching a portion of the media using a die punch.

5. A method of obtaining a portion of a media containing a dried bio-sample for use in an assay, comprising: removing a portion of the media containing the dried bio-sample; folding the portion; and transferring the portion into a receptacle.

6. The method of claim 5, wherein folding the portion comprises folding the portion into a curved shape.

7. The method of claim 6, wherein the entire portion is curved.

8. The method of claim 5, wherein transferring the portion comprises moving the portion through a chute having a maximum cross sectional dimension less than the maximum cross sectional dimension of the portion.

9. The method of claim 5, wherein the portion removed is circular prior to folding.

10. The method of claim 5, wherein removing the portion comprises punching a portion of the media using a die punch.

11. The method of claim 1, further comprising orienting the removed portion within the receptacle so that the longest dimension of the removed portion is substantially vertical within the receptacle.

12. An apparatus for obtaining a portion of a media containing a dried bio-sample for use in an assay, comprising: a punch for removing a portion of the media containing a dried bio-sample, said punch having a punching face with a maximum cross sectional dimension; and a chute for transferring the portion removed by the punch, the chute having a minimum cross sectional dimension less than the maximum cross sectional dimension of the face of said punch, said chute having an inlet below the bottom face of the punch.

13. The apparatus of claim 12, wherein said chute comprises a portion at an angle to the mid-longitudinal axis of the punch.

14. The apparatus of claim 13, wherein said chute includes an outlet at an angle relative to said angular portion.

15. The apparatus of claim 14, wherein said outlet has a mid-longitudinal axis oriented generally parallel to the mid-longitudinal axis of said punch.

16. The apparatus of claim 14, wherein said outlet is configured to engage a receptacle for retaining the portion.

17. The apparatus of claim 12, further comprising a receptacle for retaining the portion.

18. The apparatus of claim 12, further comprising an ejector pin for retaining a portion of the portion removed from the media containing a dried bio-sample.

19. The apparatus of claim 18, further comprising a second ejector pin.

20. The apparatus of claim 19, wherein said second ejector pin has a length different from that of said ejector pin.

21. The apparatus of claim 12, further comprising a detector adapted to detect the passage of the removed portion through the chute.

22. The apparatus of claim 21, further comprising a computer controlled mechanism for moving said chute once the removed portion has passed through said chute.

23. The apparatus of claim 12, further comprising a computer controlled mechanism configured to advance a receptacle underneath said chute.

24. The apparatus of claim 12, further comprising an ultraviolet radiation emitter for selectively exposing surfaces of the device coming into contact with a sample to said radiation.

25. The apparatus of claim 24 wherein the sample contacting surfaces include the punch and/or the chute.
